(19) United States
(12) Patent Application Publication
(10) Pub. No.: US 2018/0201394 A1
(43) Pub. Date: Jul. 19, 2018

(54) SPACE FLIGHT BODY WITH A DRIVE UNIT AND WITH A FUEL MATERIAL GENERATING DEVICE FOR A SPACE FLIGHT BODY

(71) Applicant: Airbus Defence and Space GmbH, Taufkirchen (DE)

(72) Inventors: Walter JEHLE, Horgenzell (DE); Hans REUCK, Berlin (DE)

(21) Appl. No.: 15/869,330

(22) Filed: Jan. 12, 2018

(30) Foreign Application Priority Data
Jan. 13, 2017 (EP) 17151463.1

(51) Int. Cl. B64G 1/40; F02K 9/50; F02K 9/42; C25B 1/10; C25B 9/08

(52) U.S. Cl. CPC B64G 1/402; F02K 9/50; B64G 1/10; C25B 1/10; C25B 9/08; F02K 9/425

(57) ABSTRACT

A space flight body, in particular a satellite, is proposed, with a drive unit which is operated with hydrogen and oxygen and serves for a maneuvering of the space flight body, and with a fuel material generating device with at least one electrolyzer, which is configured for periodically generating hydrogen and oxygen and comprises at least one electrolysis cell having at least one alkaline electrolyte, wherein the fuel material generating device comprises at least one first storage tank for a storage of the generated hydrogen and at least one second storage tank for a storage of the generated oxygen, allowing the gas for at least one jet nozzle to be retrievable from the two storage tanks by the drive unit via a duct.

### STATE OF THE ART

The invention relates to a space flight body with a drive unit and with a fuel material generating device for a space flight body.

Drive units for a space flight body, working on a basis of hydrazine and nitrogen tetroxide have already been proposed.

The objective of the invention is in particular to make a generic device available with improved characteristics regarding quick and simple on-site generating of a fuel for a space flight body. The objective is achieved, according to the invention, by the features of patent claim 1 while advantageous implementations and further developments of the invention may be gathered from the subclaims.

### Advantages of the Invention

The invention proposes a space flight body, in particular a satellite, with a drive unit which is operated with hydrogen and oxygen and serves for a maneuvering of the spaceflight body, and with a fuel material generating device for a space flight body, in particular for a satellite, with at least one electrolyzer, which is configured for periodically generating hydrogen and oxygen and comprises at least one electrolysis cell having at least one alkaline electrolyte, wherein the fuel material generating device comprises at least one first storage tank for a storage of the generated hydrogen and at least one second storage tank for a storage of the generated oxygen, allowing the gas for at least one jet nozzle to be retrievable from the two storage tanks by the drive unit via a duct. Preferably the electrolyzer is configured for a repetitive production of hydrogen and oxygen. Preferentially, in particular water is split in the electrolyzer into molecular oxygen and molecular hydrogen via electric power, under energy consumption. Principally, another chemical substance containing hydrogen atoms and oxygen atoms may be used as a reactant instead of water. By a “space flight body” is in particular, in this context, a human-built flight body for outer space to be understood. A variety of space flight bodies are conceivable which are deemed expedient by someone skilled in the art, e.g. rockets, space probes, space shuttles, spaceships, space capsules, space stations and/or especially preferably satellites. “Periodical” is in particular to mean, in this context, repetitive. Preferably it is to mean both cyclically repetitive and particularly preferably a-cyclically repetitive. Especially preferentially it is in particular to mean repetitive from time to time, phase-wise. An “electrolysis cell” is in particular, in this context, to mean a unit with at least two electrodes, at least one of which is preferably embodied as a hydrogen electrode and another one of which is embodied as an oxygen electrode, with an electrical circuit connecting the two electrodes, with at least one electrolyte arranged between the two electrodes, and/or with an electrolyte-filled or ion-conducting membrane arranged at least between the two electrodes. Preferably the unit is configured for executing a redox reaction, in which, under energy input implemented as electric power, a reactant, preferably water, is split up for the purpose of producing a first gas, preferably molecular hydrogen, and a second gas, preferably molecular oxygen. By an “electrolyte” is in particular an ion-conducting substance, preferentially implemented as a solution, e.g. an alkaline solution, to be understood. Furthermore a variety of alkaline electrolytes, deemed expedient by someone skilled in the art, are conceivable, e.g. a potassium hydroxide solution. “Configured” is in particular to mean specifically programmed, designed and/or equipped. By an object being configured for a certain function is in particular to be understood that the object fulfills and/or implements said certain function in at least one application state and/or operation state.

The drive unit is preferably configured to provide a chemical propulsion, in particular advantageously by bipropellants. Principally however any other fuel systems are conceivable in which hydrogen and oxygen are processed and which are deemed expedient by someone skilled in the art. In particular, the drive unit is configured for processing a chemical mixture, in particular advantageously of hydrogen and oxygen. In particular, such processing may be effected via an “external mixture generation” and/or via an “internal mixture generation”. An “external mixture generation” is in particular to mean that the hydrogen stored under pressure is blown, in particular pumped, with a low overpressure into a suction tube leading to a combustion chamber. The hydrogen is mixed with the oxygen prior to entering the combustion chamber. This mixture may be ignited externally following a compression in the combustion chamber. An “internal mixture generation” is in particular to mean that the gaseous hydrogen and the gaseous oxygen are injected into the combustion chamber directly under high pressure, in particular between 80 bar and 120 bar. In particular, the loaded mixture may be cooled and then ignited via a catalytic burner. Principally a combination of the two types of mixture generation is also conceivable, and/or any further type of mixture generation deemed expedient by someone skilled in the art is also conceivable. The thrust generated by the combustion of oxygen and hydrogen is in particular intended for a maneuvering of the space flight body. Herein the thrust drives the space flight body. The drive unit in particular comprises at least one jet nozzle, preferably at least two jet nozzles. In particular, the jet nozzle may be movably mounted on the drive unit, for the purpose of in particular preferably providing a steering of the space flight body. In particular, the jet nozzles may be implemented identically, in particular advantageously they are mounted in such a way that they are movable with respect to one another, to inn particular achieve a high level of mobility.

By the implementation of the fuel material generating device according to the invention, in particular a device may be made available by means of which hydrogen and oxygen may be provided periodically, in particular under pressure, for drives, in particular for a space flight body, in an advantageously simple manner. In particular, an advantageously small number of active components are required. Preferably in this way in particular advantageously simple and fast on-site production of a fuel material for a space flight body is achievable. This in particular allows providing an environment-friendly water-based drive system for space flight bodies as “green systems”. For this purpose the water is in particular electrolyzed and the components hydrogen and oxygen are made available to the drive system, in particular under increased pressure. These systems need to be small, light-weight and reliable. This means using passive components which are as simple as possible and dispensing with sensors, control components, pumps for cooling, compressors and water pumps. A drive system of this kind is usually not frequently in use, which means over the years it is sporadically operated repeatedly and irregularly several hundred times to several thousand times.

It is moreover proposed that the at least one electrolysis cell is implemented by a matrix cell. By a “matrix cell” is in particular, in this context, an electrolysis cell to be understood in which the electrolytes are fixated in a matrix, preferably in a porous, fine-pored matrix.

Preferably the matrix is arranged, with the electrolytes, in particular on at least one of the electrodes of the electrolysis cell. This allows providing a particularly advantageous electrolysis cell. In particular, an advantageously passive electrolysis cell with a low number of active components may be rendered available.

It is also proposed that the at least one electrolyzer comprises at least one water reservoir which is configured for an interim storage of water for an electrolysis process cycle. Preferentially the electrolysis cell comprises the at least one water reservoir. The at least one water reservoir is in particular configured for an interim storage of precisely the quantity of water that is required for an electrolysis process cycle. The water reservoir preferably holds less than 50 g, preferentially less than 30 g and especially preferentially less than 10 g of water. A “water reservoir” is in particular to mean, in this context, a unit for storage, in particular for interim storage, of water. A variety of reservoirs are conceivable, deemed expedient by someone skilled in the art, for example, containers, tanks and/or stores. This in particular allows directly providing water for the electrolysis. In particular, a defined quantity of water for the electrolysis may be rendered available.

It is preferentially proposed that the fuel material generating device comprises at least one first pressure compensation valve, which is connected to the water reservoir and with a hydrogen line via a duct and is configured for a pressure compensation between water and hydrogen. Preferably the pressure compensation valve is configured to compensate a pressure between the water reservoir and the hydrogen line. In this way in particular a pressure of the water in the water reservoir and/or of the hydrogen in the hydrogen line is reliably adjustable. Preferentially it is possible to adjust a pressure of the water in the water reservoir and/or of the hydrogen in the hydrogen line in an advantageously passive fashion. A reliable adjustment of a pressure is achievable.

It is further proposed that the fuel material generating device comprises at least one first storage tank for a storage of generated hydrogen and at least one second storage tank for a storage of generated oxygen. Preferably, if required for jet nozzles of the space flight body, the produced gases are retrievable from the storage tanks. In this way an advantageous storage of the gases is achievable. In particular, long-term supply of the gases is achievable.

The invention is furthermore based on a method for operating the fuel material generating device. It is preferably proposed that, on starting an electrolysis process cycle, a defined quantity of water is introduced into a water reservoir of an electrolyzer of the fuel material generating device. By an “electrolysis process cycle” is in particular, in this context, a defined process cycle of the electrolyzer to be understood in which the electrolyzer generates hydrogen and oxygen. It is preferably to be understood as an operative cycle which is in particular defined and is carried out periodically. Especially preferentially the electrolysis process cycle takes a defined time. This in particular allows rendering a defined quantity of hydrogen and oxygen available, in particular in an advantageously defined fashion, in particular under pressure, for drives, in particular for the space flight body.

Moreover it is proposed that the water is conveyed from the water reservoir of the electrolyzer to the electrolysis cell under low pressure. By “low pressure” is in particular, in this context, a pressure to be understood which is at least approximately equivalent to an ambient pressure. Preferably a deviation of the pressure from the ambient pressure is maximally 2 bar, preferentially no more than 1.5 bar and especially preferably maximally 1 bar. It is preferably in particular to mean an absolute pressure of maximally 2 bar, preferentially no more than 1.5 bar and particularly preferably maximally 1 bar. In this way a conveyance of the water is achievable, with little energy required, in an advantageously simple fashion. If the pressure in the electrolysis cell is low, i.e. close to an ambient pressure, the water may in particular be conveyed to the electrolysis cell with a small overpressure of the electrolysis cell.

It is also proposed that an electrolysis process of the electrolysis process cycle is terminated automatically if the water in the water reservoir of the electrolyzer is used up or a desired pressure level of the produced gases has been reached. This advantageously allows periodically, in particular in a defined fashion, providing a defined quantity of hydrogen and oxygen, in particular under pressure, for drives, in particular for the space flight body. In this way a defined electrolysis process cycle may be rendered available in an advantageously simple manner. Preferably an automatic termination of the electrolysis process cycle is achievable in an advantageously secure manner.

Further it is proposed that during the electrolysis process cycle hydrogen and oxygen are generated with a pressure of at least 30 bar. Preferably, during the electrolysis process cycle hydrogen and oxygen are generated with a pressure of at least 50 bar. Particularly preferably, during the electrolysis process cycle hydrogen and oxygen are generated with a pressure of no more than 100 bar. Preferentially the hydrogen and the oxygen are conveyed into the storage tanks if a defined pressure is exceeded in the electrolysis cell. This in particular allows providing hydrogen and oxygen with an advantageously high pressure. Preferably the gases are in particular storable without an additional active pressure increase. In particular a number of active components may be kept low.

It is furthermore proposed that the gases produced during an electrolysis process cycle are conveyed into storage tanks. Preferably the gases produced during the electrolysis process are conveyed into storage tanks if a defined pressure is exceeded. The gases are preferentially conveyed into the storage tanks in particular without an additional active pressure increase. This allows achieving an advantageous storage of the gases. In particular a long-term supply of the gases is achievable.

Beyond this it is proposed that, following an electrolysis process, a hydrogen line of the electrolyzer is connected to an oxygen line of the electrolyzer and the residual gases are discharged into an environment. Preferably, following an electrolysis process the hydrogen line of the electrolyzer is coupled with the oxygen line of the electrolyzer. A coupling is in particular effected for the purpose of a pressure compensation between the hydrogen line and the oxygen line, to discharge the gases without a difference pressure occurring. Preferentially the electrolysis cell is deaerated via the hydrogen line and the oxygen line until maximally ambient pressure is reached. Preferably a deaeration is effected via a valve. This allows reliably lowering a pressure in the electrolysis cell for a following electrolysis process cycle. If the pressure in the electrolysis cell is low, i.e. close to an ambient pressure, the water may be conveyed to the electrolysis cell in particular just with a low overpressure. In this way preferentially an energy requirement of the electrolyzer may be kept low.

It is also proposed that an electrolysis process cycle may be started if there is sufficient energy for an electrolysis process cycle as well as sufficient space in the storage tanks of the fuel material generating device. It is preferably possible to start an electrolysis process cycle if an energy threshold value is exceeded in an energy storage of the fuel material generating device and a pressure in the storage tanks falls below a pressure threshold value. Herein the electrolysis process cycle is preferably started automatically. This in particular allows ensuring that there is always a sufficient quantity of gas in the storage tanks. Preferably it is in this way furthermore achievable that the gases need not be produced directly if a fuel material is required. In particular, an advantageously autonomous fuel material generating device may be made available.

It is moreover proposed that the implementation of the method is effected under conditions of reduced or increased gravity. Preferably this method is to be used in outer space, e.g. at μg in a space flight body, e.g. a spaceship or a satellite, in a process in a space flight body under accelerations between 10⁻⁶ xg and 10 xg, on a planet, like Mars, and/or on a satellite, like the Moon. The g values are herein in particular to be understood to be on a planet and/or on an asteroid or in a flying space flight body. Principally however a g value may be drastically increased for procedural reasons, e.g. to 100 xg. To give an example, an installation and/or a reactor may be exposed to an artificial process acceleration which differs from the indicated g values. By “conditions of reduced gravity” are herein in particular conditions to be understood in which there is a gravitational effect of no more than 0.9 xg, advantageously of no less than 1*10⁻³ xg, preferably of minimally 1*10⁻⁶ xg and particularly preferably minimally 1*10⁻⁸ xg. By “conditions of increased gravity” are herein in particular conditions to be understood under which there is a gravitational effect of at least 1.1 xg, preferably up to maximally 10 xg. The gravitational effect may be produced by gravitation and/or artificially by acceleration. Principally the g values may be drastically increased for procedural reasons. “g” is to designate the value of the gravitational acceleration on Earth, i.e. 9.81 m/s².

The fuel material generating device according to the invention, the space flight body and the method are herein not to be limited to the application and implementation described above. In particular, for the purpose of fulfilling a functionality herein described, the fuel material generating device according to the invention, the space flight body and the method may comprise a number of individual elements, structural components and units that differs from a number that is mentioned here.

By way of the invention it is possible to implement an environment-friendly drive. In particular, hydrazine, which is highly poisonous and harmful to the environment, may be dispensed with. Instead of that, water is carried along in the space flight body, which is converted into the fueling substances hydrogen and oxygen.

### DRAWINGS

Further advantages will become apparent from the following description of the drawings. In the drawings an exemplary embodiment of the invention is represented. The drawings, the description and the claims contain a plurality of features in combination. Someone skilled in the art will purposefully also consider the features separately and will find further expedient combinations.

It is shown in:

FIG. 1 a space flight body with a fuel material generating device according to the invention and with a drive unit, in a schematic representation,

FIG. 2 the fuel material generating device according to the invention with an electrolyzer comprising an electrolysis cell, and with two storage tanks, in a schematic representation,

FIG. 3 the electrolysis cell of the electrolyzer with an integrated water reservoir, in a schematic exploded sectional view,

FIG. 4 a schematic flow chart of a method for operating the fuel material generating device according to the invention,

FIG. 5 a diagram of a measurement report of the pressures, of the current flowing and of the voltage applied over time, during an electrolysis process cycle, and

FIG. 6 the space flight body with the fuel material generating device and with the drive unit, in a schematic view from the rear.

### DESCRIPTION OF THE EXEMPLARY EMBODIMENT

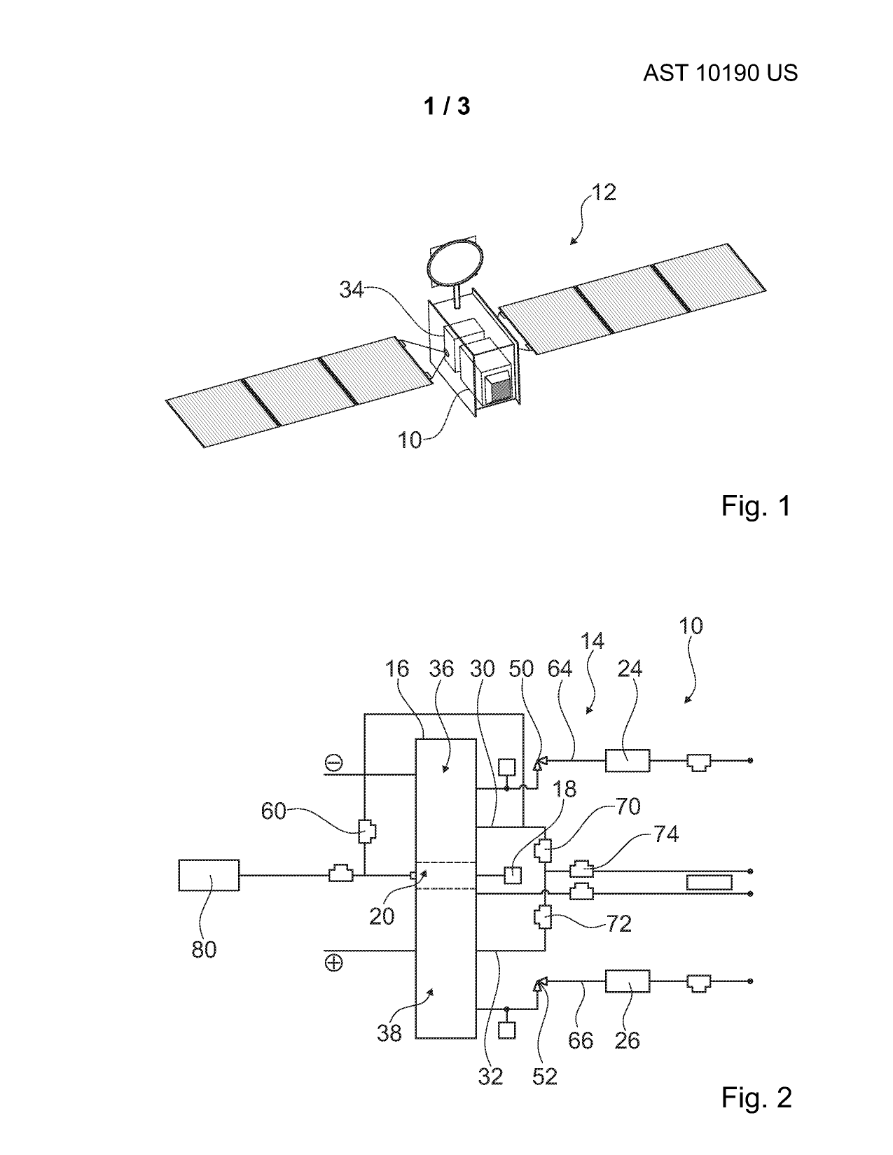

FIGS. 1 and 6 show a space flight body 12. The space flight body 12 is implemented by a satellite. Principally however a different implementation of the space flight body 12, deemed expedient by someone skilled in the art, would also be conceivable, e.g. as a rocket, a space probe, a space shuttle, a spaceship, a space capsule and/or a space station. The space flight body 12 is configured to be used in outer space, under conditions of reduced or increased gravity. The space flight body 12 comprises a fuel material generating device 10. Furthermore the space flight body 12 comprises a drive unit 34. The drive unit 34 serves for a maneuvering of the space flight body 12 in outer space. The drive unit 34 comprises at least one jet nozzle 35, which is not shown in detail. The drive unit 34 is operated with hydrogen and oxygen. The drive unit 34 comprises at least one combustion chamber (not shown in detail). To give an example, the at least one jet nozzle 35 is arranged downstream of the combustion chamber. As an example, the drive unit 34 comprises one single jet nozzle 35. It would herein in particular be conceivable that the jet nozzle 35 is arranged movably and/or that at least one guiding direction of the jet nozzle is implemented variably. Alternatively a plurality of jet nozzles would be conceivable which are, for example, embodied identically or differently, and which in particular have different orientations for implementing different maneuvering directions.

The fuel material generating device 10 is designed for the space flight body 12. The fuel material generating device 10 comprises an electrolyzer 14. The electrolyzer 14 is configured for periodically generating hydrogen and oxygen. The electrolyzer 14 is configured for repetitively generating hydrogen and oxygen. The electrolyzer 14 is configured for splitting up water into molecular oxygen and molecular hydrogen via an electrical current under energy consumption. The electrolyzer 14 comprises an electrolysis cell 16 (FIG. 2).

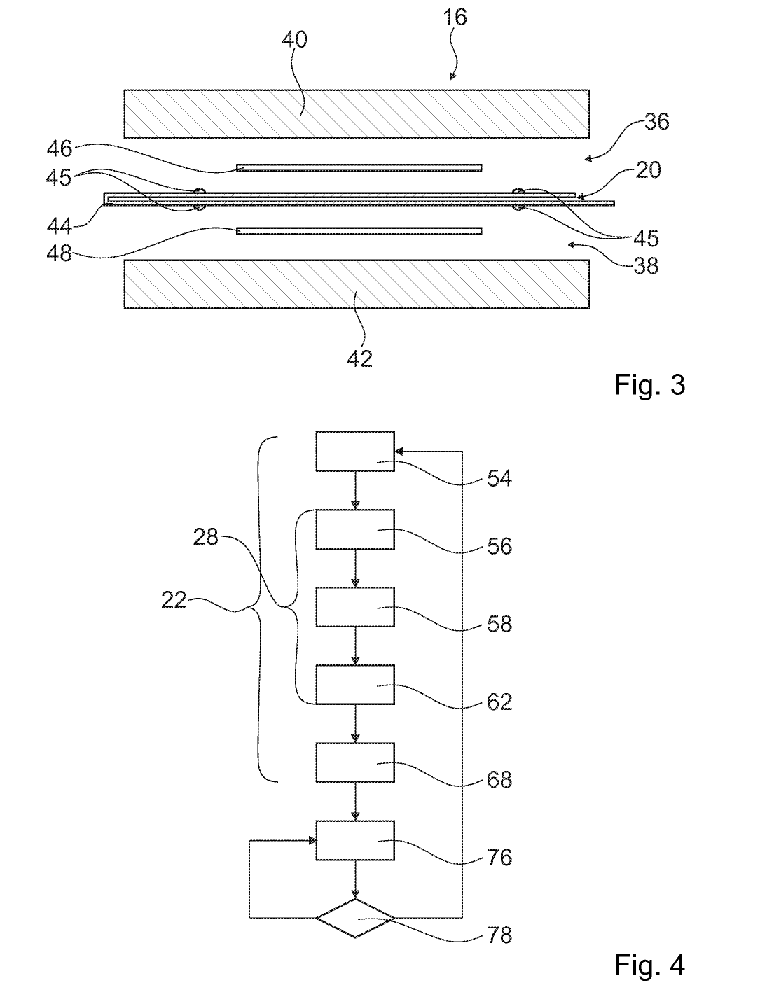

The electrolysis cell 16 is implemented by a matrix cell. The electrolysis cell 16 forms two fluid spaces 36, 38. The electrolysis cell 16 forms a fluid space 36 for the hydrogen and a fluid space 38 for the oxygen. The two fluid spaces 36, 38 are partially separate from one another. Furthermore the electrolysis cell 16 comprises two wall elements 40, 42, which delimit respectively one of the fluid spaces 36, 38 from an outside. The wall elements 40, 42 are configured to close off the fluid spaces 36, 38 against a gas exchange with an environment. The wall elements 40, 42 are each embodied plate-shaped. The wall elements 40, 42 are each implemented by a flange. The wall elements 40, 42 are made of an electrically insulating material. Principally however a different implementation of the wall elements 40, 42, which is deemed expedient by someone skilled in the art, would also be conceivable. The electrolysis cell 16 further comprises a frame 44. The frame 44 is arranged between the two fluid spaces 36, 38. The frame 44 comprises an integrated diaphragm, which is not visible in detail. The diaphragm implements a membrane, which is arranged between a first fluid space 36 and a second fluid space 38 in an axial direction. The membrane is configured for accommodating electrolytes 18. The electrolysis cell 16 comprises alkaline electrolytes 18. Principally however other electrolytes 18, which are deemed expedient by someone skilled in the art, would also be conceivable. Furthermore the frame 44 comprises integrated sealings 45. The sealings 45 are respectively embodied by an elevated sealing contour which is configured to provide a sealing effect. The sealings 45 are respectively configured to contact an opposite-situated wall element 40, 42 for sealing the fluid spaces 36, 38. The sealings 45 are respectively configured to be pressed against the wall elements 40, 42. The sealings 45 are integrally connected to a remaining portion of the frame 44. The electrolysis cell 16 moreover comprises two electrodes 46, 48 implementing a cathode and an anode. The electrodes 46, 48 are arranged in one of the fluid spaces 36, 38 respectively. The electrodes 46, 48 abut on the frame 44 on opposite sides (FIG. 3).

Furthermore, the two fluid spaces 36, 38 are connectable via a hydrogen line 30 and an oxygen line 32.

The electrolyzer 14 also comprises a water reservoir 20, which is configured for an interim storage of water for an electrolysis process cycle 22. The water reservoir 20 is configured for an interim storage of precisely the quantity of water which is required for an electrolysis process cycle 22. The water reservoir 20 holds less than 50 g, preferably less than 30 g and especially preferentially less than 10 g of water. The water reservoir 20 holds, for example, 5 g of water. The water reservoir 20 is integrated in the frame 44 of the electrolysis cell 16. The water reservoir 20 is connected to the (not visible) diaphragm of the frame 44 (FIG. 3). The water reservoir 20 is filled from a water storage 80.

The fuel material generating device 10 further comprises a first storage tank 24 for a storage of produced hydrogen and a second storage tank 26 for a storage of produced oxygen. The first storage tank 24 is connected to the first fluid space 36 of the electrolysis cell 16 via a second hydrogen line 64 of the electrolyzer 14. Between the first fluid space 36 and the first storage tank 24, an overpressure valve 50 is arranged in the second hydrogen line 64. Furthermore, the second storage tank 26 is connected to the second fluid space 38 of the electrolysis cell 16 via a second oxygen line 66 of the electrolyzer 14. Between the second fluid space 38 and the second storage tank 26, an overpressure valve 52 is arranged in the second oxygen line 66 (FIG. 2). Principally a configuration is feasible in which no storage tanks are made use of and the produced gases are used directly.

FIG. 4 shows a schematic flow chart of a method for operating the space flight body 12 with the drive unit 34 and with the fuel material generating device 10. In the method electrolysis process cycles 22 are carried out in irregular intervals. An implementation of the method is effected under conditions of reduced or increased gravity. An implementation of the method is effected in outer space. An implementation of the method is effected in outer space directly in the space flight body 12. The electrolysis process cycles 22 are implemented in the fuel material generating device 10. On starting an electrolysis process cycle 22, a defined quantity of water is introduced into the water reservoir 20 of the electrolyzer 14 of the fuel material generating device 10 in a first method step 54. For example, 5 g of water are added per cycle. When the water is in the water reservoir 20 of the electrolyzer 14, it is possible to apply a voltage to the electrodes 46, 48 in a further method step 56, and the proper electrolysis process 28 starts. In the electrolysis process 28 hydrogen and oxygen are generated. The water of the water reservoir 20 of the electrolyzer 14 is conveyed to the electrolysis cell 16 under low pressure. With the start of the electrolysis process 28, furthermore a first pressure compensation valve 60 is opened to allow a pressure compensation taking place between water and hydrogen. The fuel material generating device 10 comprises the first pressure compensation valve 60. The first pressure compensation valve 60 is connected to the water reservoir 20 and to the hydrogen line 30 via a duct. The first pressure compensation valve 60 is configured for a pressure compensation between water and hydrogen. The hydrogen line 30 is further connected to the first fluid space 36. The electrolyzer 14 comprises the first pressure compensation valve 60. During the electrolysis process cycle 22 hydrogen and oxygen are generated with a pressure of at least 30 bar. During the electrolysis process cycle 22 hydrogen and oxygen are generated with a pressure of 50 bar. During the electrolysis process 28 the pressure in the electrolysis cell 16 increases until the overpressure valves 50, 52 open at a defined pressure in a further method step 58. The overpressure valves 50, 52 open, for example, at 50 bar. Due to the opening of the overpressure valves 50, 52, the generated gases are conveyed into the allocated storage tanks 24, 26. The gases generated during the electrolysis process cycle 22 are thus conveyed into the storage tanks 24, 26. From these storage tanks 24, 26 the drive unit 34 may retrieve gas for the jet nozzle via a further duct, if required. In a further method step 62, the electrolysis process 28 ends automatically when the water in the water reservoir 20 is used up. The electrolysis process 28 of the electrolysis process cycle 22 is completed automatically when the water in the water reservoir 20 of the electrolyzer 14 is used up. Herein the electrolysis cell 16 is still under pressure. Therefore, in another method step 68 the hydrogen line 30 is connected to the oxygen line 32 and the gases are then discharged into an environment. Following the electrolysis process 28, the hydrogen line 30 of the electrolyzer 14 is thus connected to the oxygen line 32 of the electrolyzer 14 and the residual gases are discharged into an environment. The coupling of the hydrogen line 30 and the oxygen line 32 is effected for a pressure compensation between the lines, to discharge the gases without a difference pressure occurring. The coupling is effected by opening two connecting valves 70, 72, which connect the hydrogen line 30 and the oxygen line 32. The residual gases are together dischargeable into an environment via a further valve 74. Herein the electrolysis cell 16 is deaerated until maximally ambient pressure is reached. The quantity of discharged gases is herein rather small as the volumes of the fluid spaces 36, 38 in the electrolysis cell 16 are structurally kept in minor dimensions. After deaeration the electrolysis process cycle 22 is completed. The water reservoir 20 may then be re-filled with water. In this state the pressure in the fluid spaces 36, 38 of the electrolysis cell 16 is low, i.e. close to an ambient pressure, thus allowing the water to be conveyed into the water reservoir 20 with a small overpressure. Following completion of an electrolysis process cycle 22, a new electrolysis process cycle 22 may thus be started. A new electrolysis process cycle 22 may be started if there is sufficient energy for an electrolysis process cycle 22 as well as sufficient space in the storage tanks 24, 26 of the fuel material generating device 10. For this purpose, the loading state of an energy storage (not shown in detail) of the fuel material generating device 10 is monitored in a further method step 76. Furthermore, a pressure in the storage tanks 24, 26 of the fuel material generating device 10 is monitored. A branching 78 then comprises a check whether a threshold value of the loading state of the energy storage of the fuel material generating device 10 has been exceeded and whether a pressure in the storage tanks 24, 26 of the fuel material generating device 10 has fallen below a corresponding threshold value. If the threshold value of the loading state of the energy storage of the fuel material generating device 10 has not been exceeded or a pressure of the storage tanks 24, 26 of the fuel material generating device 10 has not fallen below the corresponding threshold value, the method step 76 is repeated. If the threshold value of the loading state of the energy storage of the fuel material generating device 10 has not been exceeded or a pressure of the storage tanks 24, 26 of the fuel material generating device 10 has not fallen below the corresponding threshold value, a new electrolysis process cycle 22 is started and the method step 54 is repeated.

The generated hydrogen and oxygen are conveyed from the storage tanks 24, 26 to the drive unit 34 via a further duct (not shown). In the drive unit 34 a processing of a chemical gas mixture is carried out. In the combustion chamber the gas mixture is ignited, for example using a catalytic burner. The combustion of the gas mixture of hydrogen and oxygen generates a thrust. The thrust is carried out and/or forwarded by the jet nozzle 35. The jet nozzle 35 is arranged downstream of the at least one combustion chamber. The space flight body 12 is driven by the thrust. Alternatively the processing of the gas mixture may be already carried out in the further duct, the gas mixture being in such a case conveyed directly into the at least one combustion chamber of the drive unit 34 for combustion. It would furthermore also be conceivable to convey the generated gases from the fluid spaces 36, 38 directly into the drive unit 34.

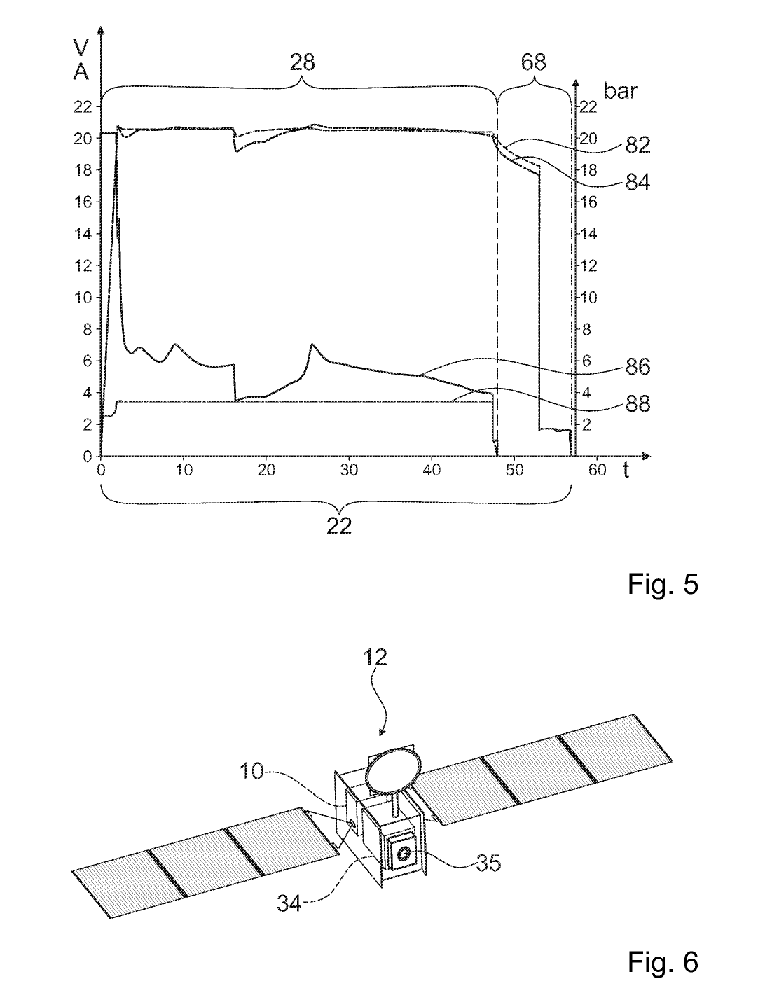

FIG. 5 shows an exemplary diagram of a measurement report of a hydrogen pressure 82 in the first fluid space 36, of an oxygen pressure 84 in the second fluid space 38, a flowing current 86 of the electrolysis cell 16 and an applied voltage 88 of the electrolysis cell 16 over time during an electrolysis process cycle 22. The diagram shows the hydrogen pressure 82 in the first fluid space 36 and the oxygen pressure 84 in the second fluid space 38 in bar, over a time t. The diagram further shows the current 86 of the electrolysis cell 16 in Ampère A, over the time t. The diagram furthermore shows the voltage 88 of the electrolysis cell 16 in Volt V, over the time t. Herein the time period shown represents an electrolysis process cycle 22 with an electrolysis process 28 and with a following deaeration according to method step 68. The time t is given in minutes.

1. A space flight body, in particular a satellite, with a drive unit which is operated with hydrogen and oxygen and serves for a maneuvering of the space flight body, and with a fuel material generating device with at least one electrolyzer, which is configured for periodically generating hydrogen and oxygen and comprises at least one electrolysis cell having at least one alkaline electrolyte, wherein the fuel material generating device comprises at least one first storage tank for a storage of the generated hydrogen and at least one second storage tank for a storage of the generated oxygen, allowing the gas for at least one jet nozzle to be retrievable from the two storage tanks by the drive unit via a duct.

2. The space flight body according to claim 1, wherein
the at least one electrolysis cell is implemented by a matrix cell.

3. The space flight body according to claim 1, wherein
the at least one electrolyzer comprises at least one water reservoir, which is configured for an interim storage of water for an electrolysis process cycle.

4. The space flight body according to claim 3, comprising
at least one first pressure compensation valve, which is connected to the water reservoir and with a hydrogen line via a duct and is configured for a pressure compensation between water and hydrogen.

5. A method for operating a space flight body with a drive unit and of a fuel material generating device according to claim 1.

6. The method according to claim 5, wherein
on starting an electrolysis process cycle, a defined quantity of water is introduced into a water reservoir of an electrolyzer of the fuel material generating device.

7. The method according to claim 6, wherein
the water is conveyed from the water reservoir of the electrolyzer to the electrolysis cell under low pressure.

8. The method at least according to claim 6, wherein
an electrolysis process of the electrolysis process cycle is terminated automatically when the water in the water reservoir of the electrolyzer is used up.

9. The method according to claim 5, wherein
during the electrolysis process cycle hydrogen and oxygen are generated with a pressure of at least 30 bar.

10. The method according to claim 5, wherein
the gases produced during an electrolysis process cycle are conveyed into storage tanks.

11. The method according to claim 5, wherein
following an electrolysis process, a hydrogen line of the electrolyzer is connected to an oxygen line of the electrolyzer and the residual gases are discharged into an environment.

12. The method according to claim 5, wherein
an electrolysis process cycle may be started if there is sufficient energy for an electrolysis process cycle as well as sufficient space in the storage tanks of the fuel material generating device.

13. The method according to claim 5, wherein
the implementation of the method is effected under conditions of reduced or increased gravity.
